(19) United States
(12) Patent Application Publication
(10) Pub. No.: US 2025/0174043 A1
(43) Pub. Date: May 29, 2025

(54) APPARATUS AND METHOD FOR RECONSTRUCTING FACIAL IMAGES USING FACIAL IDENTITY FEATURES AND STYLES

(71) Applicant: POSTECH RESEARCH AND BUSINESS DEVELOPMENT FOUNDATION, Pohang-si (KR)

(72) Inventors: Dai Jin KIM, Pohang-si (KR); Dong Min CHA, Pohang-si (KR)

(73) Assignee: POSTECH RESEARCH AND BUSINESS DEVELOPMENT FOUNDATION, Pohang-si (KR)

(21) Appl. No.: 18/943,668

(22) Filed: Nov. 11, 2024

(30) Foreign Application Priority Data
Nov. 28, 2023 (KR) 10-2023-0168440

(51) Int. Cl. G06V 40/16; G06V 10/44

(52) U.S. Cl. CPC G06V 40/172; G06V 10/44

(57) ABSTRACT

The present invention relates to an apparatus and method for reconstructing facial images, which includes a generator network including an encoder and a decoder. The encoder analyzes an occluded image to extract feature values, and the decoder restores a final facial image.

### CROSS-REFERENCE TO RELATED PATENT APPLICATION

This application claims the benefit of Korean Patent Application No. 10-2023-0168440, filed on Nov. 28, 2023, in the Korean Intellectual Property Office, the disclosure of which is incorporated herein in its entirety by reference.

### BACKGROUND OF THE INVENTION

### 1. Field of the Invention

The present invention relates to a technology for reconstructing facial images using generative adversarial networks (GANs), and more particularly, to a structure and training method of a reconstruction network, and an apparatus and method for reconstructing facial images by applying various styles, while preserving their identity.

### 2. Description of the Related Art

In general, the technology for reconstructing occluded or damaged images uses artificial intelligence neural networks to fill in the occluded or damaged areas of a given image with appropriate content to create a complete image. In particular, unlike the reconstruction of landscapes or objects, the technology for reconstructing human facial images has the characteristic that, if facial contours or key features are awkwardly reconstructed, the quality of the images significantly deteriorates.

Generative adversarial networks (GANs) are characterized by their ability to generate or restore images, such as landscape or facial images, to establish the highest possible correlation with the original.

Existing generative adversarial networks for reconstructing human facial images have focused solely on the pixel-level quality of the overall image, without understanding the shapes, contours, or features of the human face. As a result, the reconstructed facial image could not guarantee the resemblance to the actual face. In traditional generative adversarial networks, the networks have trained to optimize only two loss functions: one that reduces the difference in pixel values between the reconstructed image and the original image; and another that makes it impossible to distinguish between the reconstructed image and the original images. Therefore, this approach may result in excellent image reconstruction performance from a mechanical perspective, but it has the drawback of not necessarily producing superior results from a human perspective.

Specifically, generative adversarial networks consist of a generator network that creates images and a discriminator network that distinguishes images, and uses convolutional neural networks to process images of two or more dimensions. The training of the generative adversarial network involves the generator network creating images that mimic real ones, while the discriminator network distinguishes between the real and generated images. The two networks are trained with different goals: the generator network aims to create convincing fake images, while the discriminator network strives to accurately distinguish between the two images. Ultimately, when the generator network becomes capable of creating images that closely resemble real ones, the generator is used to create images The characteristic of generative adversarial networks is that the training involves two networks with opposing objectives learning to balance each other.

Prior literature on methods for reconstructing occluded or damaged facial images is as follows.

Korean Patent Application Publication No. 10-2023-0018316 relates to a method for reconstructing masked facial images, comprising the steps of: identifying a masked facial image included in a target reconstruction image; obtaining a mask-free facial image of a person associated with the identified masked facial image; and synthesizing the obtained mask-free facial image with the identified masked facial image.

Korean Patent No. 10-2364822 relates to a method and apparatus for reconstructing occluded areas. The method involves reconstructing an object with an occluded area to an object with the occluded area reconstructed, which is performed by an electronic device using a model, referred to as a reconstructor, which is trained using machine learning techniques to output a reconstructed object when provided with the occluded objet and associated supplementary information, the method comprising the steps of: analyzing the type of an occluded object in the image; verifying whether there is a pre-trained reconstructor based on the analyzed type of object; if it is determined that there is a reconstructor in the verification step, selecting the corresponding reconstructor; determining the need for retraining the selected reconstructor based on the supplementary information related to the analyzed type of object; and creating a reconstructed object using the selected reconstructor as is or the selected reconstructor retrained based on the supplementary information depending on the determined need.

### SUMMARY OF THE INVENTION

According to an embodiment of the present invention, an object of the present invention is to address the drawbacks of existing facial image reconstruction methods using generative adversarial networks, which restore images without a semantic understanding of facial identities. To this end, the present invention provides a method for reconstructing facial images, which incorporates the understanding and learning of facial identities to restore images. Moreover, according to another embodiment of the present invention, there is provided a method for reconstructing facial images, which can apply desired styles while preserving the facial identities by applying facial features and styles desired by users.

To achieve the above-mentioned object, the method for reconstructing facial images of the present invention uses a network trained with two loss functions, which enable the neural network to semantically understand facial images and restore images by applying specific styles. Unlike existing generative adversarial networks represented by a generator and a discriminator, the method of the present invention employs a mapping network that represents the input style and extracts feature values appropriate for a given style. The mapping network extracts feature values for an intended style using only conditional input variables, without requiring a separate input image. Moreover, the method for reconstructing facial images of the present invention includes adaptive instance normalization that applies a specific style to an image during the reconstruction by applying style feature values extracted from the mapping network to each layer of the decoder of the generator.

Conventional facial image reconstruction methods could not restore facial images while preserving their facial identities, nor could they perform the reconstruction by applying arbitrary styles to the facial images. However, the method for reconstructing facial images proposed by the present invention provides the step of reconstructing a facial image while preserving its facial identity and the step of reconstructing a facial image by applying an arbitrary style.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates the process of reconstructing an input image using a facial image reconstruction network;

FIG. 2 illustrates the steps of reconstructing a facial image in detail; and

FIG. 3 illustrates the learning process of two loss functions used to restore facial images by applying arbitrary styles, while ensuring facial identities.

### DETAILED DESCRIPTION OF THE INVENTION

Hereinafter, the description of the present invention with reference to the drawings is not limited to the specific embodiments, and various modification and several embodiments may be possible. Moreover, it should be understood that the disclosure is intended to cover all modifications, equivalents, and alternatives falling within the spirit and scope of the present invention.

In the following description, the terms such as “first”, “second”, or the like are used to describe various components, and the described components are not limited by these terms. These terms are used solely for the purpose of distinguishing one component from another.

The same reference numerals used throughout the specification designate the same components.

In the present invention, the singular forms are intended to include the plural forms as well, unless the context clearly indicates otherwise. Moreover, it should be understood that the terms such as “comprising,” “including,” “having”, or the like do not exclude the presence or addition of other functions, steps, operations, elements, components, or combinations thereof that are described in the specification.

Unless otherwise defined, all terms used herein, including technical or scientific terms, have the same meanings as those commonly understood by those skilled in the art to which the present invention pertains. The terms, such as those defined in commonly used dictionaries, should be interpreted as having meanings consistent with those in the context of the relevant art, and will not be interpreted in an idealized or overly formal sense unless expressly defined otherwise herein.

Furthermore, in the description with reference to the accompanying drawings, the same components will be given the same reference numerals regardless of the drawing symbols, and redundant descriptions thereof will be omitted. In the description of the present invention, if it is determined that a detailed description of the well-known art associated with the present invention may unnecessarily obscure the gist of the present invention, the detailed description thereof will be omitted.

Hereinafter, preferred embodiments of the present invention will be described in detail with reference to the attached drawings.

An apparatus for reconstructing facial images of the present invention may comprise a generator network including an encoder and a decoder, wherein the encoder may analyze an occluded image to extract feature values, and the decoder may restore a final facial image. Moreover, the encoder and the decoder may be connected in a skip-connection manner using a spatial style map, and the spatial style map may be generated by inputting a style value into a mapping network. Furthermore, the generator network may be trained with a style consistency loss function, an adversarial loss function, and an identity preserving loss function, wherein the style consistency loss function may allow the encoder to analyze the occluded image to extract feature values, the adversarial loss function may ensure that the reconstructed image is indistinguishable from the original image in visual terms, and the identity preserving loss function may ensure that the identity of the reconstructed face is as similar as possible to the identity of the original image. In addition, the method for reconstructing facial images of the present invention may comprise the steps of: analysing, by an encoder of a generator network, an occluded image to extract feature values; and reconstructing, by a decoder of the generator network, a final facial image.

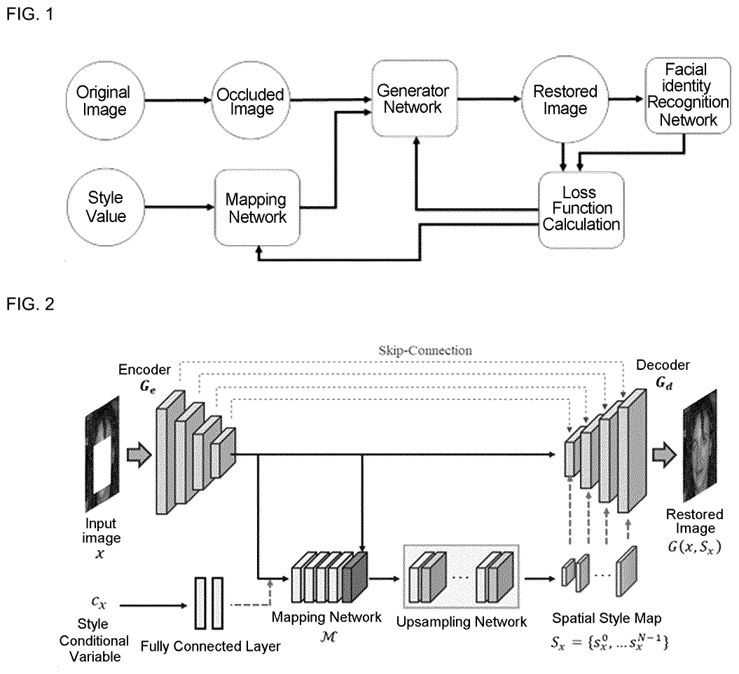

FIG. 1 illustrates the training process of a facial image reconstruction network. An occluded image is generated from an original image by applying an arbitrary mask, and a separately input style value is input to a mapping network, which generates a spatial style map for the corresponding style. The occluded image and the spatial style map are input to the generator network, which generates a reconstructed image. The reconstructed image is then used to calculate a loss function, with an output of an identity recognition network being used as an input to the loss function to ensure the preservation of the reconstructed facial identity. The calculated loss function is fed back to the mapping network and the generator network, thereby optimizing the mapping network and the generator network to guide the training of the facial image reconstruction network.

FIG. 2 illustrates the overall structure of the generator network. The generator network of the present invention performs facial image reconstruction for occluded faces. A rough approximation of the facial image (an average form) is reconstructed, and then an identity preserving loss function is used to correct and adjust the roughly reconstructed facial image to match the target indicated by the identity information.

The occluded image input to the generator network is analyzed by the encoder to extract feature values, and then finally reconstructed by the decoder. The encoder and the decoder apply skip-connection, allowing data reconstruction with high learning efficiency. The generator network has a structure where the encoder that analyzes the information of the image and the decoder that generates an image from the analyzed information are connected, and the skip-connection represents a structure where some of the feature values are delivered to the decoder, allowing the information used in the encoder to be considered during the decoding process of the decoder. In this case, the spatial information of the analyzed image is also conveyed to the decoder, which takes this information into account when generating the image. As a result, the decoder gains a rough outline of what it needs to create, enhancing the learning efficiency. Moreover, the generator network receives feature values representing the generated style, which are input into the mapping network as conditions corresponding to the style. The mapping network, consisting of convolutional layers, can generate spatial feature values instead of linear feature values, and these style features are referred to as spatial style maps. The spatial style map starts from a size of 8×8 pixels and is then upsampled through an upsampling network consisting of upsampling layers, expanding to twice its size and ultimately to a style map of 128×128 pixels, which is the size of the final image. Each size of the style map is applied to each layer of the decoder of the generator network, resulting in the final reconstruction of the facial image with the specific style applied.

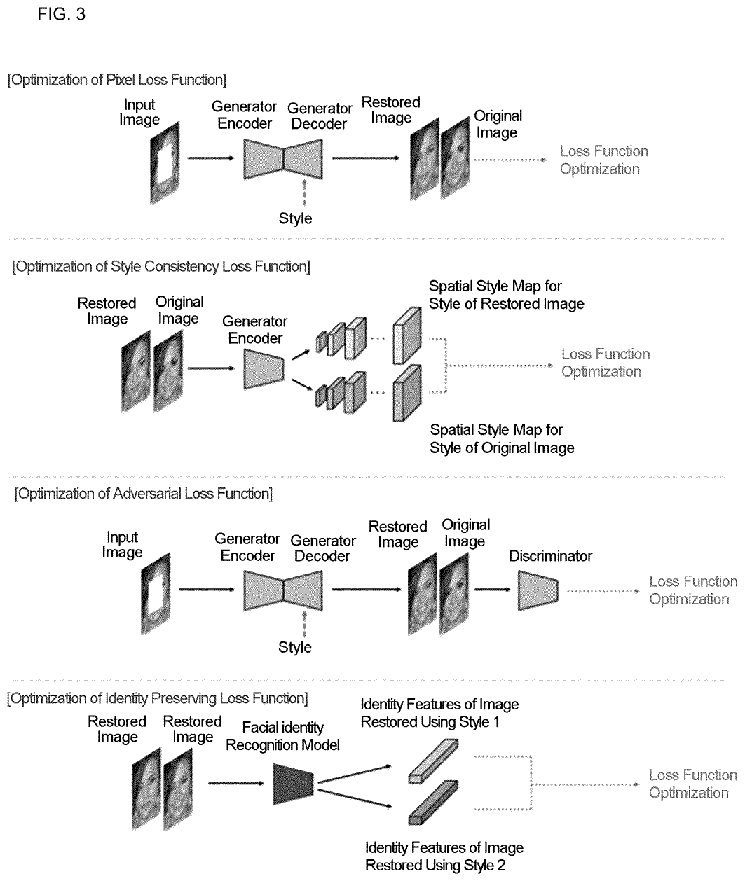

FIG. 3 illustrates the loss functions that need to be optimized for model training. The pixel loss function guides the reconstruction process to make the reconstructed image similar to the original image in terms of pixel dimensions, and it is trained to minimize the Manhattan distance between the two images. The style consistency Loss function guides the proposed network to apply a specific style in each separate domain, and it is trained to minimize the Euclidean distance between the spatial style maps extracted from the original image with a specific style and the reconstructed image using the same style.

The style consistency loss function allows the encoder to analyze the feature information of the image. For example, the generator network is not trained to distinguish between facial images with beards and those without beards. Instead, the generator network restores the facial images using average statistic values without distinguishing between such faces. As a result, the generator network may produce either a face with a beard or a face without a beard. Moreover, the generator network cannot arbitrarily control whether it generates facial images with or without a beard. By using the style consistency loss function, the generator network can understand information about average features from two datasets that the user has pre-classified depending on the presence or absence of a beard. For example, if dataset A consists entirely of images with beards and dataset B consists of entirely of images without beards, the generator network can understand that these two datasets have different average features. In other words, when given two facial images with beards, the encoder of the generator network trained in this way will recognize that ‘there is a commonality between the two images’, and the two pieces of information output from these two images will internally share the information about the common style. The style consistency loss function ensures and confirms to the generator network that ‘there is a commonality between the two images’ by reducing the distance between the features representing these two pieces of information.

The adversarial loss function guides the reconstruction of the image so that the reconstructed image is visually indistinguishable from the original image. At the same time, while the discriminator network is trained to clearly distinguish between the original image and the reconstructed image when each is input separately, the generator network applies the loss function of the discriminator network in reverse, establishing an adversarial learning relationship between the two networks.

The identity preserving Loss function ensures that the reconstructed facial identity is as similar as possible to the original image and also guides the training of the generator network to maintain a consistent identity even when applying various styles. The identity preserving Loss function is trained by minimizing the Euclidean distance between the original image and the reconstructed image using the feature values extracted from the pre-trained face recognition network. Here, unlike the style that deals with a single distinctive feature, the identity preserving loss function extracts complex features such as the eyes, nose, mouth, and gender that represent the identity of the face. This is mainly studied in the field of face recognition, where various facial features such as shapes, colors, and forms are mixed (i.e., some features may be used, while others may not) to roughly ‘represent’ the identity of a person. In other words, the identity preserving loss function does not directly distinguish or identify a person, but rather roughly ‘represent’ the information about a person's identify as an N-dimensional vector. In practice, facial recognition does not clearly distinguish images based on the distribution of feature values, as in image classification. Instead, it compares the features of a given face with those of another face, identifying the face as the same person if the features are similar, and as a different person if they are not. In the present invention, the identity preserving loss function restores the image by providing approximate information, such as ‘Based on what I know, the rest probably looks like this,” from the obscured face. While it cannot determine “who” the person is, the face recognition network roughly understands standardized faces of people from a database of tens of millions of images, and it conveys the information it knows to the generative adversarial network.

The method for training the generative adversarial network according to the present invention is as follows:

### Algorithm 1: Training Procedure

Prepare datasets for Style 1 and Style 2.
Configure the encoder of the generator network, the decoder of the generator network, the mapping network, and the discriminator network to be trained with loss functions.
Fix the identity recognition network so that it is not trained with loss functions.
While training is in progress, do the following:
   Extract a sample image from the dataset for Style 1.
   Create a mask and apply it to the extracted sample image to use as an input image.
   Step 1: Restore the image with the same style, Style 1.
      [symbol] Extract feature values for the input image by the encoder of the generator network.
      [symbol] Input the extracted feature values into the mapping network to extract the spatial style map for Style 1.
      [symbol] Input the extracted feature values and the style map into the decoder of the generator network to restore the image. The reconstructed image has Style 1 applied.
      [symbol] Optimize the ‘pixel loss function’ and ‘style consistency loss function’ using the reconstructed image and the original image to train the encoder of the generator network, the decoder of the generator network, and the mapping network.
   Step 2: Restore the image with a different style, Style 2
      [symbol] Input the feature values extracted in Step 1 into the mapping network to extract the spatial style map for Style 2.
      [symbol] Input the extracted feature values and the style map into the decoder of the generator network to restore the image. The reconstructed image has Style 2 applied.
      [symbol] Optimize the ‘adversarial loss function’ and the ‘identity preserving loss function’ using the reconstructed image from Step 2, the original image, and the reconstructed image from Step 1, to train the encoder of the generator network, the decoder of the generator network, and the mapping network.
      [symbol] Optimize the ‘adversarial loss function’ using the reconstructed image from Step 2 and the original image to train the discriminator.
   Conversely, perform the same steps as in Steps 1 and 2 by sampling images from the dataset for Style 2 and converting them to Style 1.
End while

All images processed in the present invention have the same size of 128×128, and before reconstructing the facial images to resemble those of individuals with similar identities, the pixel-level information of the images must be roughly reconstructed. After roughly reconstructing the occluded image, the mean squared error (MSE) between the reconstructed image and the original image from the database is calculated. The roughly reconstructed image can provide information on how a person's face might look, including color, contours, and approximate locations of the eyes, nose, and mouth, even if the identity of the reconstructed facial image cannot be determined. Here, the discriminator network of the aforementioned GAN plays a role in making the roughly reconstructed facial image resemble a real person, and the identity preserving loss function is then used to identify the detailed features of the person and modify the roughly reconstructed facial image to have an identity as similar as possible based on the knowledge the face recognition network possesses. In this process, since creating a facial image is the primary goal, the mean squared error function between images is given the height weight during training. Subsequently, the discriminator network and the style-preserving and identity preserving loss functions contribute to creating a facial image with an identity as similar as possible, and each of these functions is assigned different learning weights.

While the embodiments of the present invention have been described with reference to the accompanying drawing, it will be understood by those skilled in the art that the embodiments of the present invention can be implemented in other specific forms without changing the technical idea or essential features of the present invention. Therefore, it is to be understood that the embodiments described above are merely illustrative of the present invention and should not be construed as limiting the invention.

What is claimed is:

1. An apparatus for reconstructing facial images, comprising:
a generator network including an encoder and a decoder, wherein the encoder analyzes an occluded image to extract feature values, and the decoder restores a final facial image.

2. The apparatus for reconstructing facial images according to claim 1, wherein the encoder and the decoder are connected in a skip-connection manner using a spatial style map, and
wherein the spatial style map is generated by inputting a style value into a mapping network.

3. The apparatus for reconstructing facial images according to claim 1, wherein the generator network is trained with a style consistency loss function, an adversarial loss function, and an identity preserving loss function,
wherein the style consistency loss function allows the encoder to analyze the occluded image to extract feature values,
wherein the adversarial loss function ensures that the reconstructed image is indistinguishable from the original image in visual terms, and
wherein the identity preserving loss function ensures that the identity of the reconstructed face is as similar as possible to the identity of the original image.

4. A method for reconstructing facial images, comprising the steps of:
analysing, by an encoder of a generator network, an occluded image to extract feature values; and
reconstructing, by a decoder of the generator network, a final facial image.

5. The method for reconstructing facial images according to claim 4, wherein the encoder and the decoder are connected in a skip-connection manner using a spatial style map, and
wherein the spatial style map is generated by inputting a style value into a mapping network.

6. The method for reconstructing facial images according to claim 4, wherein the generator network is trained with a style consistency loss function, an adversarial loss function, and an identity preserving loss function,
wherein the style consistency loss function allows the encoder to analyze the occluded image to extract feature values,
wherein the adversarial loss function ensures that the reconstructed image is indistinguishable from the original image in visual terms, and
wherein the identity preserving loss function ensures that the identity of the reconstructed face is as similar as possible to the identity of the original image.
